(19) United States
(12) Patent Application Publication
(10) Pub. No.: US 2026/0173104 A1
(43) Pub. Date: Jun. 18, 2026

(54) MASTER INFORMATION BLOCK (MIB) CONTENT TRANSMISSION

(71) Applicant: Lenovo (United States) Inc., Morrisville, NC (US)

(72) Inventors: Karthikeyan GANESAN, Nauheim (DE); Ali Ramadan Ali, Kraiburg am Inn (DE); Ravi KUCHIBHOTLA, Chicago, IL (US)

(21) Appl. No.: 18/980,767

(22) Filed: Dec. 13, 2024

(51) Int. Cl. H04W 72/231; H04W 56/00; H04W 72/12

(52) U.S. Cl. CPC H04W 72/231; H04W 56/0015; H04W 72/12

(57) ABSTRACT

Various aspects of the present disclosure relate to a cell or network communication device utilizes a physical downlink control channel (PDCCH) when transmitted a master information block (MIB). For example, the cell may configure a default parameter for a common search space and a PDCCH and transmit contents of the MIB via the PDCCH. In some cases, the default parameter may be based on a subcarrier spacing (SCS) or frequency range of the cell and/or device types for UEs associated with the cell.

### TECHNICAL FIELD

The present disclosure relates to wireless communications, and more specifically to the transmission of master information block (MIB) contents, such as via a physical downlink control channel (PDCCH).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to transmit MIB contents via PDCCH.

A network entity for wireless communication is described. The network entity may be configured to, capable of, or operable to perform one or more operations as described herein. For example, the network entity may comprise at least one memory and at least one processor coupled with the at least one memory and configured to cause the network entity to configure a default parameter for a common search space and a PDCCH and transmit contents of a MIB via the PDCCH.

A method performed or performable by network entity is described. The method may comprise configuring a default parameter for a common search space and a PDCCH and transmitting contents of a MIB via the PDCCH.

In some implementations of the network entity and method described herein, the default parameter is based on a subcarrier spacing (SCS) or frequency range of the network entity.

In some implementations of the network entity and method described herein, the default parameter is based on device types for UEs associated with the network entity.

In some implementations of the network entity and method described herein, the network entity and method may further be configured to, capable of, performed, performable, or operable to transmit the contents of the MIB via a common search space of a control resource set type 0 (CORESET #0).

In some implementations of the network entity and method described herein, the network entity and method may further be configured to, capable of, performed, performable, or operable to map a broadcast channel (BCH) carrying the MIB to downlink control information (DCI) carried by the PDCCH.

In some implementations of the network entity and method described herein, the contents of the MIB comprise scheduling information of a system information block type 1 (SIB1).

In some implementations of the network entity and method described herein, the network entity and method may further be configured to, capable of, performed, performable, or operable to scramble the PDCCH using a cell identifier (ID) for the network entity.

In some implementations of the network entity and method described herein, the default parameter for the common search space comprises a first parameter associated with bandwidth limited (BL) UEs and a second parameter associated with non-BL UEs.

In some implementations of the network entity and method described herein, the common search space comprises a first common search space associated with UEs of a first type and a second common search space associated with UEs of a second type and the network entity and method may further be configured to, capable of, performed, performable, or operable to allocate resource groups (REGs) of control channel elements (CCEs) of a CORESET #0 to the first common search space or the second common search space.

In some implementations of the network entity and method described herein, the contents of the MIB comprise device specific MIB contents associated with BL UEs, device specific MIB contents associated with non-BL UEs, and common MIB contents associated with BL UEs and non-BL UEs.

A UE for wireless communication is described. The UE may be configured to, capable of, or operable to perform one or more operations as described herein. For example, the UE may comprise at least one memory and at least one processor coupled with the at least one memory and configured to cause the UE to detect a synchronization signal block (SSB) during an initial cell search procedure and decode a PDCCH carrying contents of a MIB.

A processor for wireless communication is described. The processor may be configured to, capable of, or operable to perform one or more operations as described herein. For example, the processor may comprise at least one controller coupled with at least one memory and configured to cause the processor to detect an SSB during an initial cell search procedure and decode a PDCCH carrying contents of a MIB.

A method performed or performable by a UE is described. The method may comprise detecting an SSB during an initial cell search procedure and decoding a PDCCH carrying contents of a MIB.

In some implementations of the UE, processor, and method described herein, the contents of the MIB comprise a system frame number (SFN) associated with a network entity that transmitted the SSB.

In some implementations of the UE, processor, and method described herein, the UE, processor, and method may further be configured to, capable of, performed, performable, or operable to detect a common search space of a CORESET #0 that maps a BCH carrying the MIB to DCI carried by the PDCCH.

### BRIEF DESCRIPTION OF THE DRAWINGS

FIG. 1 illustrates an example of a wireless communications system in accordance with aspects of the present disclosure.

FIG. 2 illustrates an example mapping of downlink transport channels to physical channels in accordance with aspects of the present disclosure.

FIG. 3 illustrates an initial access procedure sequence in accordance with aspects of the present disclosure.

FIG. 4A-4D illustrate example mapping of synchronization signal (SS) blocks and CORESET #0 in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by an NE in accordance with aspects of the present disclosure.

FIG. 9 illustrates a flowchart of a method performed by a UE in accordance with aspects of the present disclosure.

### DETAILED DESCRIPTION

During cell search operations, a UE receives and utilizes synchronization signals from a cell (e.g., a base station or other network entity) to determine information that enables the UE to access the cell. For example, the cell may transmit synchronization signal block (SSBs) every 5 milliseconds or with other periodicities (e.g., 5 ms, 10 ms, 20 ms, and so on). To provide for coverage over an entire cell area, the cell may perform beam sweeping. Beam sweeping entails communication of one or more cell defining SSB bursts (or burst sets), where each SSB burst includes a set of SSBs, and where each SSB may be transmitted by a different or separate beam.

In some examples, before connecting with a network communication device, a UE detects a MIB and a system information block (SIB), such as a SIB Type 1 (SIB1). The MIB, which is carried by a physical broadcast channel (PBCH) that is part of a SSB, provides information about the network communication device to the UE, such as information related to a reference subcarrier spacing (SCS), information about a control channel for different SIBs, information identifying a physical downlink shared channel (PDSCH), information about demodulation reference signal (DMRS) positioning, and so on. The SIB1 provides information associated with an initial attachment procedure between the UE and the network communication device, as well, as scheduling information for other SIBs. The UE decodes the MIB and SIB1 to camp on a cell associated with the network communication device.

For 5G (new radio, or NR) wireless access technologies, the SSB burst size is 5 ms (e.g., half of a radio frame), where the SSBs are transmitted in a first half or a second half of a radio frame. Based on the frequency range and subcarrier spacings of the cell, SSB burst sizes (e.g., 5 ms) may accommodate a maximum of 64 candidate SSBs. Typically, a base station transmits the synchronization signals (SSs, such as a primary synchronization signal (PSS) and a secondary synchronization signal (SSS)), along with (e.g., having the same periodicity) a PBCH, as an SS block. Further, the base station may transmit a CORESET #0, which contains scheduling information for a SIB1, via a default periodicity (e.g., 20 ms).

However, in some cases, the cell may benefit from transmitting information related to the cell or network communication device (e.g., MIB contents) via a message with a periodicity that is different from the default periodicity of the SSBs. The systems and methods described herein introduce such a mechanism, where the cell or network communication device utilizes the PDCCH when transmitted the MIB.

For example, the cell may configure a default parameter for a common search space and a PDCCH and transmit contents of the MIB via the PDCCH. In some cases, the default parameter may be based on the SCS or frequency range of the cell and/or device types for UEs associated with the cell. The cell, therefore, may map a broadcast channel carrying the MIB to downlink control information (DCI) carried by the PDCCH. In doing so, the cell may realize enhanced flexibility during MIB content transmissions by utilizing different periodicities for the transmissions, among other benefits.

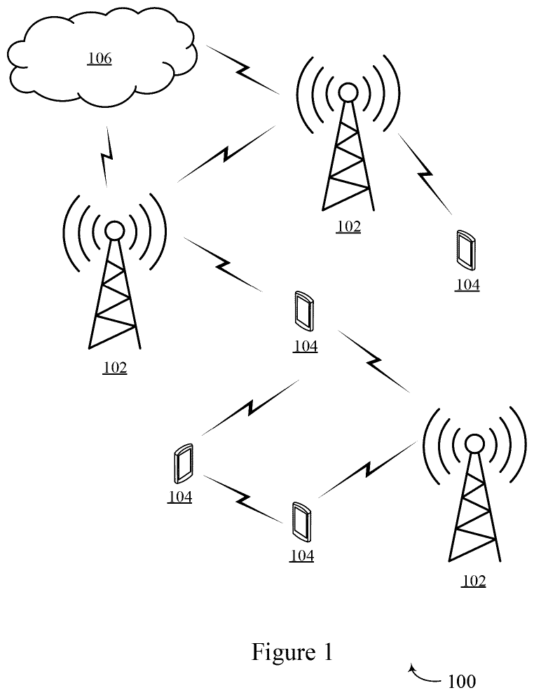

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a cell (e.g., a base station) utilizes PDCCH when transmitted a MIB during various operations, such as initial access procedures for UEs served by or otherwise associated with the cell. According to one or more aspects, a network entity (e.g., a base station) may configure a default parameter for a common search space and a PDCCH and transmit contents of an MIB via the PDCCH.

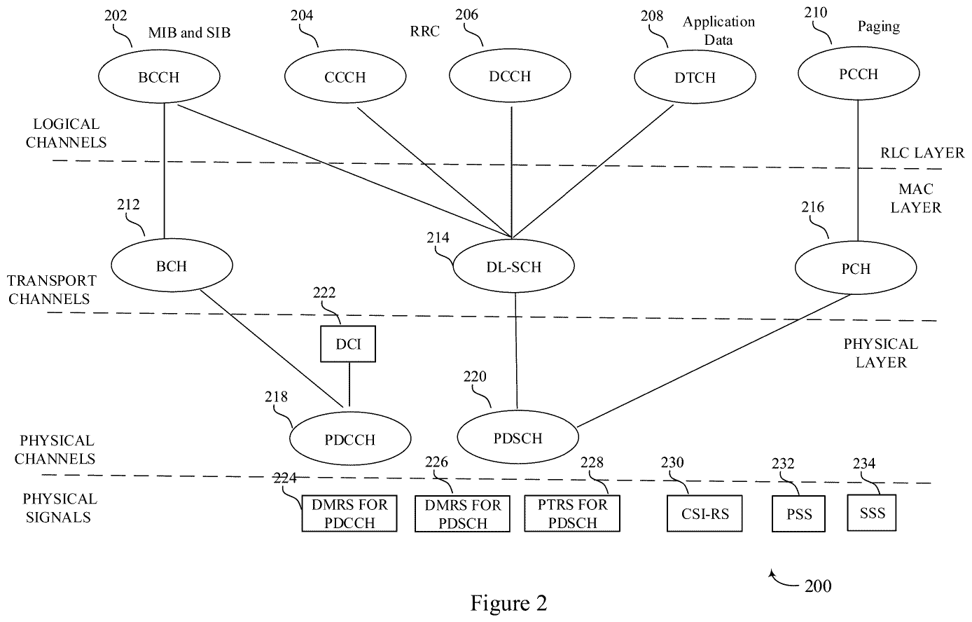

FIG. 2 illustrates an example mapping 200 of downlink transport channels to physical channels in accordance with aspects of the present disclosure. The mapping 200 of downlink transport channels to physical channels facilitates the transmission of information or data associated with logical channels. For example, a MIB or SIBs, associated with a broadcast control channel (BCCH) 202, is mapped to broadcast channel (BCH) 212, radio resource control (RRC) information, associated with a common control channel (CCCH) 204 or downlink control channel (DCCH) 206, is mapped to a downlink shared channel (DL-SCH) 214, application data, associated with a dedicated traffic channel (DTCH) 208, is also mapped to the DL-SCH 214, and paging data, associated with a paging control channel (PCCH) 210, is mapped to a paging channel (PCH) 216.

The transport channels, DL-SCH 214 and PCH 216, are then mapped to a PDSCH 220, which carries physical signals, such as a DMRS 226 and a phase tracking reference signal (PTRS) 228. The mapping may also facilitate the mapping of other signals, such as a CSI-RS 230 and synchronization signals (PSSs 323 and/or SSSs 234).

As described herein, the BCH 212, carrying the MIB (e.g., the MIB content), is mapped to DCI 222 of a PDCCH 218. The PDCCH 218 may then carry a DMRS 224 associated with the MIB content. For example, the BCH 212 maps to the PDCCH 218 via a new common search space definition or via a type 0 common search space within a CORESET #0 (e.g., instead of transmitting the MIB using a PBCH). Table 1 presents a configuration of a search space that is mapped to the BCH 212.

TABLE 1

| Type | Search space | RNTI | Usage |
|---|---|---|---|
| Type 0 PDCCH | Common search | B-RNTI or SI- | To receive MIB and required |
| | | RNTI | minimum system information |

In some cases, the DCI 222 provides scheduling information associated with a UE receiving an SIB1 (e.g., avoiding transmission of a separate DCI to schedule the SIB1). The UE may be predefined or configured with a new common RNTI (e.g., a B-RNTI or SI-RNTI) and a new common DCI format for decoding the MIB content and/or scheduling information for decoding the SIB1 from the PDCCH 218 transmitted in a cell. Table 2 presents example MIB content.

TABLE 2

| | | |
|---|---|---|
| Cell barred | 1 bit | Value barred means that the cell is barred |
| DMRS type A position | 1 bit | Position of (first) DM-RS for downlink |
| Intra frequency reselection | 1 bit | Controls cell selection/reselection to intra- |
| | | frequency cells when the highest ranked cell is |
| | | barred, or treated as barred by the UE, |
| ssb-subcarrier offset | 4 bit | Corresponds to k_{SSB,} which is the frequency |
| | | domain offset between SSB and the overall |
| | | resource block grid in number of subcarriers |
| subCarrierSpacingCommon | 1 bit | Subcarrier spacing for SIB1, Msg. 2/4 for initial |
| | | access, paging and broadcast SI-messages. If the |
| | | UE acquires this MIB on an FR1 carrier |
| | | frequency, the value scs15or60 corresponds to 15 |
| | | kHz and the value scs30or120 corresponds to 30 |
| | | kHz. If the UE acquires this MIB on an FR2 |
| | | carrier frequency, the value scs15or60 |
| | | corresponds to 60 kHz and the value scs30or120 |
| | | corresponds to 120 kHz. |
| SFN | 10 bit | System frame number goes from 0 to 1023 |
| Freq domain allocation | X bits | SIB1 freq allocation |
| Time domain allocation | 4 bit | SIB1: Row index to the table, depending on the |
| | | CORESET#0 multiplexing pattern with SSB |
| Modulation and coding scheme | 5 bit | MCS value for SIB1 |
| VRB to PRB mapping | 1 bit | SIB1: interleaved or not |
| Redundancy version | 2 bit | SIB1: RV number between retransmission |

In some embodiments, the device type for the UE (e.g., the UE 104) may affect interpretation or decoding of MIB contents. For example, the UE may be a bandwidth limited (BL) device (e.g., an Internet of Things (IoT) device), a non-BL device (e.g., an enhanced mobile broadband (eMBB) device), a cell barred device, and so on. The UE, based on its device type, may ignore or not decode certain MIB content (e.g., a BL UR may ignore VRB to PRB mapping for receiving SIB1). Such information may be signaled by the SIB1.

In some embodiments, a separate modulation and coding scheme (MCS) table may be configured for the system information. For example, instead of 5 bits to indicate the MCS value, 2 or 3 bits may be used to select different code rates within quadrature phase shift keying (QPSK) modulation.

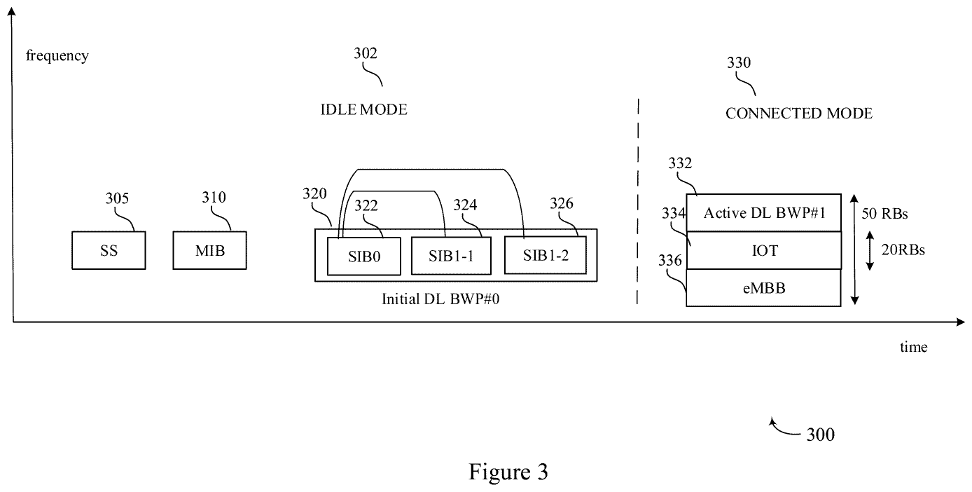

FIG. 3 illustrates an initial access procedure sequence in accordance with aspects of the present disclosure. The initial access procedure sequence 300 may include, for an idle mode 302 of a UE, a synchronization signal 305, a MIB 310, and an initial bandwidth partition (BWP) 320. The BWP 320 includes a SIB0 322 and two SIB1s (e.g., SIB1-1 and SIB1-2) 324, 326, which are associated with different device types of UEs.

In some cases, the MIB 310 may indicate SIB1 scheduling information, such as when the SIB1 is configured for interpretation by all UEs (e.g., UEs of both eMBB and IoT device types). The SIB1 scheduling information may include an initial BWP configuration, paging related information, random access channel (RACH) resource configuration, unified access control barring information, and so on. Thus, the frequency domain allocation for the SIB1 is based on transmitting the SIB1 within the bandwidth of a BL UE (e.g., 3/5 MHz), which can involve more time domain symbols to compensate for fewer frequency domain resources.

In some cases, the MIB 310 may indicate SIB0 scheduling information (e.g., cell selection criteria, such as a selection threshold to select a suitable cell for the UE performing an initial access procedure). The SIB0 may be common for all device types or the SIB0 may indicate an SIB1 that is different and/or specific to different device types. Thus, the MIB 310 may include contents configured for different devices, such as an initial BWP, a paging configuration, a RACH resource configuration, and so on.

In some cases, the SIB1 may include contents common for all device types and contents specific to different devices. For example, the SIB1 contents may include an SSB periodicity and a SSB pattern, and device specific contents (e.g., SIB1-1 324 and SIB1-2 326) associated with an initial BWP, paging configuration, RACH resource configuration, and so on.

FIG. 3 also illustrates, for a connected mode 330 of the UE in the frequency domain, an active downlink BWP 332 specific to device types, such as IoT information 334 (e.g., narrower frequency domain) and eMBB information 336 (e.g., wider frequency domain).

In some embodiments, the DCI content of PDCCH 218 carrying the MIB information and SIB0 or SIB1 scheduling information transmitted in the common search space of CORESET #0 may be scrambled with an identifier of the cell (e.g., a cell ID) or part of the identifier of the cell while the CRC of the DCI may be masked by the new common RNTI (e.g., B-RNTI).

In some embodiments, a default CORESET #0 configuration includes time-frequency resources, a quantity of time domain symbols, a mapping of information in a resource grid, a time-frequency offset with respect to the synchronization signal, and/or a mapping pattern provided as a default configuration for UEs performing an initial cell search procedure. The cell, therefore, may provide a new or enhanced common search space monitoring occasion, where a periodicity for the PDCCH reception of the MIB content is provided as a default configuration for the UEs. The default configurations for the UEs may be specified separately for various default parameters of the search space, such as different frequency ranges, SCSs and/or device types. Thus, in some cases, the network entity may separately provide a default CORESET #0 configuration for a normal UE (e.g., a non-BL UE). Additionally, for a BLUE, the network entity may provide the default CORESET #0 configuration in accordance with the parameters shown in Table 3.

TABLE 3

| | | SS block | | | Relative | Offset |
|---|---|---|---|---|---|---|
| | | and | Number of | Number of | time | RBs |
| | Device | CORESET | RBs of | Symbols for | offset to | from |
| | type | mux pattern | CORESET | CORESET | SS | Ref A |
| FR1 < 3 GHz | Normal UE | 1 | 24 | 2 | 5 | 20 |
| | BL UE | 1 | 12 | 4 | 10 | 25 |
| 3 GHz < | Normal UE | 1 | 24 | 2 | 5 | 20 |
| FR1 > 6 GHz | BL UE | 1 | 12 | 4 | 10 | 25 |

Thus, in some cases, a PDCCH default configuration (e.g., an aggregation level, number of candidates, CCE to REG mapping, interleaving, scrambling, and so on) may be provided to the UEs to decode the PDCCH carrying MIB content (e.g., PDCCH 218). Further, the default CORESET #0 configuration may be updated with monitoring and additional common search space configurations, such as a monitoring occasion. The cell may provide a periodicity for the reception of required minimum system information in SIB0/SIB1 to idle mode UEs through the MIB content.

In some embodiments, therefore, a default parameter for the common search space may include a first parameter associated with BL UEs and a second parameter associated with non-BL UEs. In some cases, the common search space may include a first common search space associated with BL UEs and a second common search space associated with non-BL UEs, where the cell may allocate REGs of CCEs of the control CORESET #0 to the first common search space or the second common search space.

A UE (e.g., the UE 104), during an initial search procedure, may detect an SSB and decode a PDCCH carrying contents of a MIB (e.g., a system frame number (SFN) associated with a cell that transmitted the SSB. The UE may detect the common search space of the CORESET #0 that maps the BCH carrying the MIB to the DCI associated with the PDCCH.

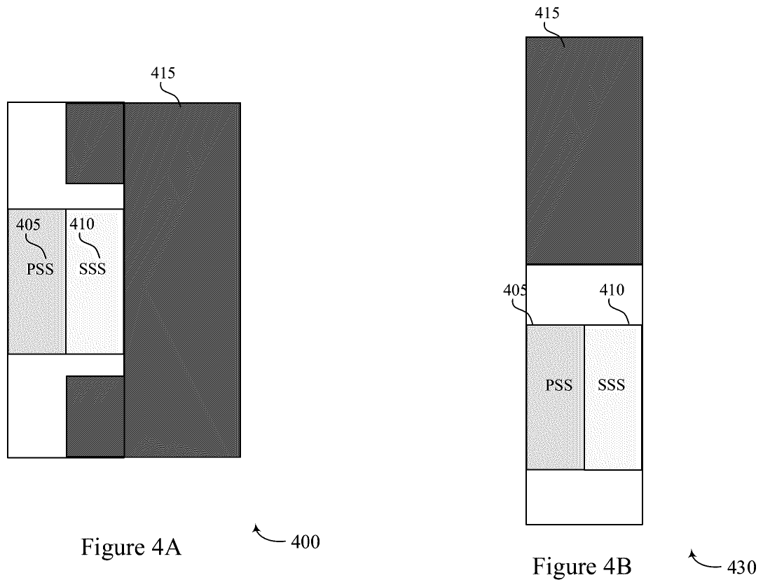

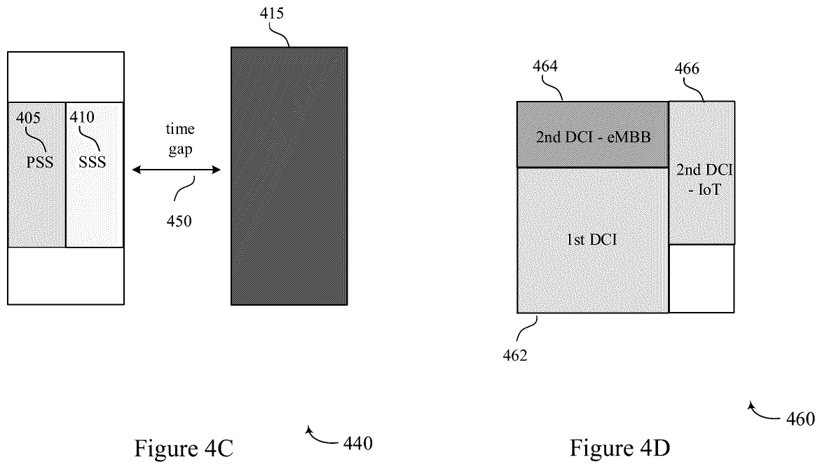

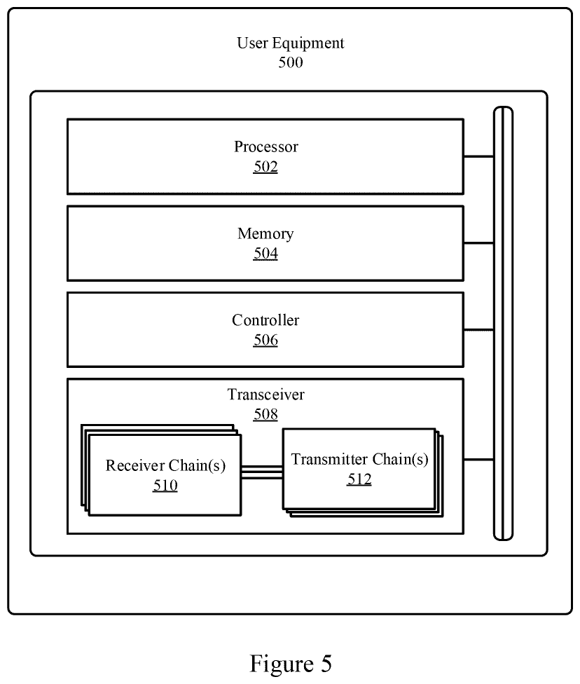

FIG. 4A-4D illustrate example mapping of SS blocks and CORESET #0 in accordance with aspects of the present disclosure. For example, FIG. 4A presents a time domain multiplexing (TDM) mapping 400 of a PSS 405 and an SSS 410 to a CORESET #0 415 without any time gap or time domain offset. FIG. 4B presents a frequency division multiplexing (FDM) mapping 430 of a PSS 405 and an SSS 410 to a CORESET #0 415. FIG. 4C presents a time divisional multiplexing (TDM) mapping 440 of the PSS 405 and SSS 410 to the CORESET #0 415 (e.g., via a time gap or time domain offset 450). FIG. 4D presents a mapping 460 of different DCIs, such as a first DCI 462 common to all device types. In some cases, the first DCI 462 may be mapped to a common search space in CORESET #0, where the first DCI 426 contains an SFN, cell barring, subcarrier offset to the other channels, and/or intra-frequency cell reselection and the second DCIs, specific to different device types (e.g., 2^{nd} DCI-eMMB 464 and 2^{nd} DCI-IoT 466), contain scheduling information to receive device specific SIB0 or SIB1 signaling for the different device types.

As described herein, there may be separate or different common search spaces for the different device types, and a cell may allocate REGs to CCEs of a CORESET #0 to the separate search spaces. For example, REGs of common search spaces for an eMBB device type (e.g., a non-BL UE) may span 20 RBs, while REGs of common search spaces for an IoT device type (e.g., a BL UE) may be allocated within the PSS/SSS bandwidth (e.g., 10-12 RBs). As another example, the bandwidth of the common search space for BL UEs may be allocated as 1-3 RBs while spanning across many symbols.

In some embodiments, a common search space may include common MIB content for all device types allocated within the PSS/SSS bandwidth (e.g., 10-12 RBs). The common MIB content may include an SFN, an SSB-subcarrier offset, a subCarrierSpacingCommon. The common search space may also include separate MIB content (e.g., separately provided for different device types), such as cell barred information, cell reselection information, SIB1 time-frequency resources, and so on). In some cases, DCI may be implemented in two stages, where first stage DCI includes common DCI content and second stage DCI includes device type specific content.

In some embodiments, a search space may be configured for each device type and the search space monitoring occasions may be separately provided to each device type as a separate row index in a table (e.g., separated for each device type).

In some embodiments, the cell may transmit MIB content with DCI scheduling information to receive SIB0 or SIB1 in the PBCH, which may avoid the cell transmitting DCI scheduled within the CORESET #0 for scheduling SIB0 or SIB1.

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein.

For example, the processor 502 may support wireless communication at the UE 500 in accordance with examples as disclosed herein. The UE 500 may be configured to support a means for detecting an SSB during an initial cell search procedure and decoding a PDCCH carrying contents of an MIB.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

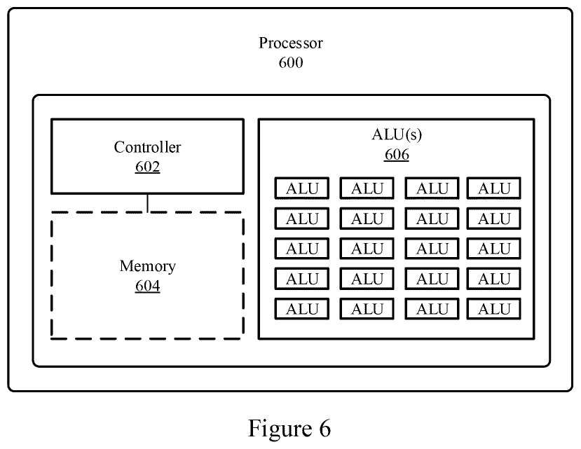

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to support a means for detecting an SSB during an initial cell search procedure and decoding a PDCCH carrying contents of an MIB.

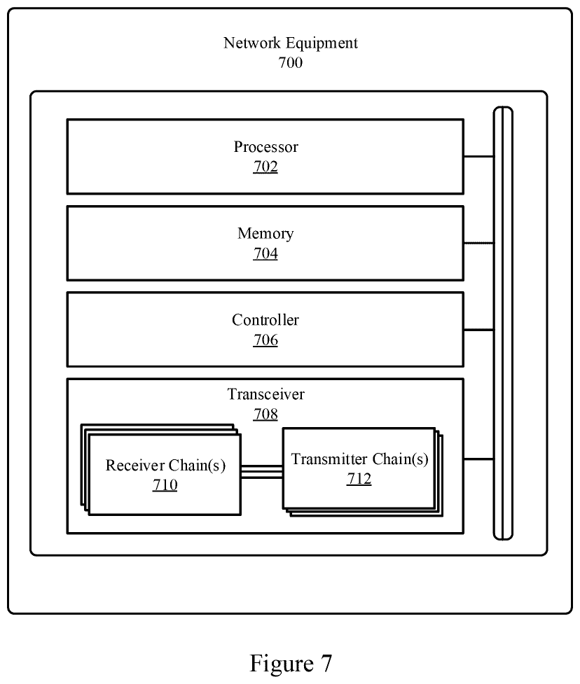

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704).

For example, the processor 702 may support wireless communication at the NE 700 in accordance with examples as disclosed herein. The NE 700 may be configured to support a means for configuring a default parameter for a common search space and a PDCCH and transmitting contents of a MIB via the PDCCH.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

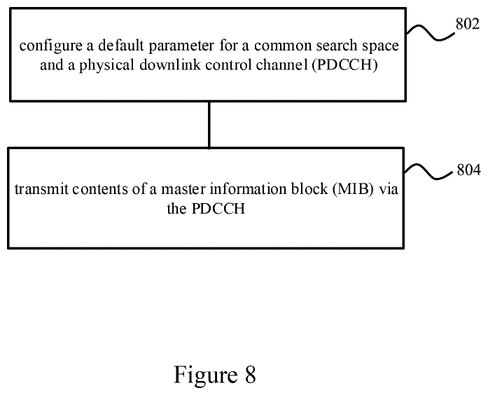

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include configuring a default parameter for a common search space and a PDCCH. The operations of 802 may be performed in accordance with examples as described herein. In some implementations, aspects of the operations of 802 may be performed by an NE as described with reference to FIG. 7.

At 804, the method may include transmitting contents of a MIB via the PDCCH. The operations of 804 may be performed in accordance with examples as described herein. In some implementations, aspects of the operations of 804 may be performed by an NE as described with reference to FIG. 7.

It should be noted that the method described herein describes a possible implementation, and that the operations and the steps may be rearranged or otherwise modified and that other implementations are possible.

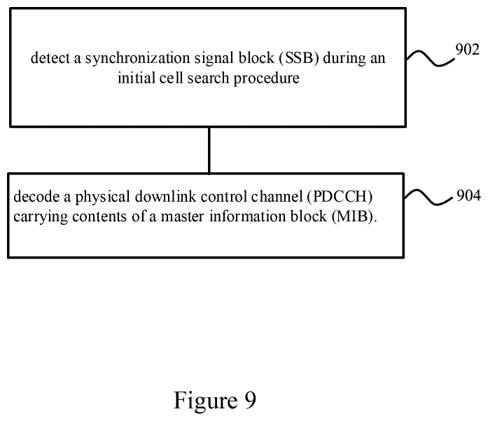

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include detecting an SSB during an initial cell search procedure. The operations of 902 may be performed in accordance with examples as described herein. In some implementations, aspects of the operations of 902 may be performed by a UE as described with reference to FIG. 5.

At 902, the method may include decoding a PDCCH carrying contents of an MIB. The operations of 904 may be performed in accordance with examples as described herein. In some implementations, aspects of the operations of 904 may be performed by a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
configure a default parameter for a common search space and a physical downlink control channel (PDCCH); and
transmit contents of a master information block (MIB) via the PDCCH.

2. The network entity of claim 1, wherein the default parameter is based on a subcarrier spacing (SCS) or frequency range of the network entity.

3. The network entity of claim 1, wherein the default parameter is based on device types for user equipment (UEs) associated with the network entity.

4. The network entity of claim 1, wherein the at least one processor is configured to cause the network entity to transmit the contents of the MIB via a common search space of a control resource set type 0 (CORESET #0).

5. The network entity of claim 1, wherein the at least one processor is further configured to cause the network entity to:
map a broadcast channel (BCH) carrying the MIB to downlink control information (DCI) carried by the PDCCH.

6. The network entity of claim 1, wherein the contents of the MIB comprise scheduling information of a system information block type 1 (SIB1).

7. The network entity of claim 1, wherein the at least one processor is further configured to cause the network entity to:
scramble the PDCCH using a cell identifier (ID) for the network entity.

8. The network entity of claim 1, wherein the default parameter for the common search space comprises:
a first parameter associated with bandwidth limited (BL) user equipment (UEs); and
a second parameter associated with non-BL UEs.

9. The network entity of claim 1, wherein the common search space comprises a first common search space associated with user equipment (UEs) of a first type and a second common search space associated with UEs of a second type; and wherein at least one processor is further configured to cause the network entity to:
allocate resource groups (REGs) of control channel elements (CCEs) of a control resource set type 0 (CORESET #0) to the first common search space or the second common search space.

10. The network entity of claim 1, wherein the contents of the MIB comprise:
device specific MIB contents associated with bandwidth limited (BL) user equipment (UEs);
device specific MIB contents associated with non-BL UEs; and
common MIB contents associated with BL UEs and non-BL UEs.

11. A method performed by a network entity, the method comprising:
configuring a default parameter for a common search space and a physical downlink control channel (PDCCH); and
transmitting contents of a master information block (MIB) via the PDCCH.

12. The method of claim 11, wherein the default parameter is based on a subcarrier spacing (SCS) or frequency range of the network entity.

13. The method of claim 11, wherein the default parameter is based on device types for user equipment (UEs) associated with the network entity.

14. The method of claim 11, wherein transmitting the contents of the MIB comprises transmitting the contents of the MIB via a common search space of a control resource set type 0 (CORESET #0).

15. The method of claim 11, further comprising:
mapping a broadcast channel (BCH) carrying the MIB to downlink control information (DCI) carried by the PDCCH.

16. A user equipment (UE) for wireless communication, comprising:
at least one memory; and
at least one processor coupled with the at least one memory and configured to cause the UE to:
detect a synchronization signal block (SSB) during an initial cell search procedure; and
decode a physical downlink control channel (PDCCH) carrying contents of a master information block (MIB).

17. The UE of claim 16, wherein the contents of the MIB comprise a system frame number (SFN) associated with a network entity that transmitted the SSB.

18. The UE of claim 16, wherein the at least one processor is further configured to cause the UE to:
detect a common search space of a control resource set type 0 (CORESET #0) that maps a broadcast channel (BCH) carrying the MIB to downlink control information (DCI) carried by the PDCCH.

19. A processor for wireless communication, comprising:
at least one controller coupled with at least one memory and configured to cause the processor to:
detect a synchronization signal block (SSB) during an initial cell search procedure; and
decode a physical downlink control channel (PDCCH) carrying contents of a master information block (MIB).

20. The processor of claim 19, wherein the at least one controller is further configured to cause the processor to:
detect a common search space of a control resource set type 0 (CORESET #0) that maps a broadcast channel (BCH) carrying the MIB to downlink control information (DCI) carried by the PDCCH.
